(19) United States
(12) Patent Application Publication
(10) Pub. No.: US 2019/0007538 A1
(43) Pub. Date: Jan. 3, 2019

(54) COMMUNICATIONS ARTICLE

(71) Applicant: KING ABDULLAH UNIVERSITY OF SCIENCE AND TECHNOLOGY, Thuwal (SA)

(72) Inventor: Hossein FARIBORZI, Thuwal (SA)

(21) Appl. No.: 16/067,661

(22) PCT Filed: Jan. 11, 2017
(86) PCT No.: PCT/IB2017/050130

§ 371 Date: Jul. 2, 2018

Related U.S. Application Data
(60) Provisional application No. 62/277,616, filed on Jan. 12, 2016.

(51) Int. Cl. H04M 1/21; G06F 1/16; G06F 3/01

(52) U.S. Cl. CPC H04M 1/21; G06F 3/016; G06F 1/163

(57) ABSTRACT

Seamless, covert communications using a communications system integrated or incorporated within an article of clothing is described. In one embodiment, the communications system is integrated or incorporated into a shoe insole and includes a haptic feedback mechanism, a communications module, a flexible pressure sensor, and a battery. The communications module includes a wireless communications module for wireless communications, a wired interface for wired communications, a microcontroller, and a battery charge controller. The flexible pressure sensor can be actuated by an individual's toe, for example, and communication between two communications nodes can be achieved using coded signals sent by individuals using a combination of long and short presses on the pressure sensor. In response to the presses, wireless communications modules can transmit and receive coded signals based on the presses.

### CROSS-REFERENCE TO RELATED APPLICATIONS

This application claims the benefit of priority to co-pending U.S. Provisional Application No. 62/277,616, entitled “COMMUNICATIONS ARTICLE,” filed on Jan. 12, 2016, the entire contents of which is incorporated herein by reference.

### BACKGROUND

Communication can be described as the exchange of information between two or more individuals to convey the intended meaning of that information through a system of semiotic rules. Among others, the steps of communication include composing a message, encoding the message as a signal, transmitting or communicating the signal, receiving the signal, decoding the signal back into the message, and interpreting the message by the recipient.

One example of communications includes a vocal conversation between individuals. Beyond vocal conversations, new forms of communications, such as wired and wireless communications, for example, offer new ways of exchanging messages between individuals. Thus, depending upon the surrounding environment, social context, and/or other factors, individuals now have several different ways to communicate with each other.

### SUMMARY

Embodiments of the present disclosure are related to a communications system incorporated in an article of apparel and configured to facilitate communications between two parties.

According to one embodiment, among others, a communications article is provided comprising an article of apparel; a haptic feedback mechanism incorporated with the article of apparel; a communications module incorporated with the article of apparel; and a flexible pressure sensor incorporated in the article of apparel to capture information for wireless communications via the communications module to a second article of apparel.

According to another embodiment, among others, a method is provided comprising the steps of receiving, via at least one computing device, a sensor signal from a flexible pressure sensor incorporated in an article of apparel; determining, via the at least one computing device, a coded signal from the sensor signal according to a messaging scheme; and initiating, via the at one computing device, a communication module to transmit the coded signal to a remote computing device.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

In addition, all optional and preferred features and modifications of the described embodiments are usable in all aspects of the entire disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

For a more complete understanding of the embodiments and the advantages thereof, reference is now made to the following description, in conjunction with the accompanying figures briefly described as follows:

FIG. 1 illustrates an example article for communications according to various embodiments described herein.

FIG. 2 illustrates an example of communications using the article for communications shown in FIG. 1 and a second article for communications according to various embodiments described herein.

FIGS. 3A and 3B are flow charts illustrating example processes for communicating between a first article of apparel and a second article of apparel according to one embodiment described herein,

FIG. 4 illustrates an example block diagram of a communications system that can be incorporated with the article shown in FIG. 1 according to various embodiments described herein.

The drawings illustrate only example embodiments and are therefore not to be considered limiting of the scope of the embodiments described herein, as other embodiments are within the scope of this disclosure. The elements and features shown in the drawings are not necessarily drawn to scale, emphasis instead being placed upon clearly illustrating the principles of the embodiments. Additionally, certain dimensions or positionings may be exaggerated to help visually convey certain principles. In the drawings, similar reference numerals between figures designate like or corresponding, but not necessarily the same, elements.

### DETAILED DESCRIPTION

The embodiments described herein can be relied upon to facilitate seamless communication between two or more parties, without the knowledge of those in the vicinity. In one embodiment, the communications system is hidden inside an article of clothing or an accessory, for example, and allows seamless, covert two way communications between individuals. Using the system, information can be sent using a “coded push” on the sender side, and that information can be received as haptic feedback (e.g., a buzz or vibration) on the receiver side.

In one embodiment, the communications system is integrated or incorporated into a shoe insole and includes a haptic feedback mechanism, a communications module, a flexible pressure sensor, and a battery. The communications module includes a wireless communications module for wireless communications, a wired interface for wired communications, a microcontroller, and a battery charge controller. The flexible pressure sensor can be actuated by an individual's toe, for example, and communication between two communications nodes can be coded by using a combination of long and short presses on the pressure sensor and the time intervals between the presses.

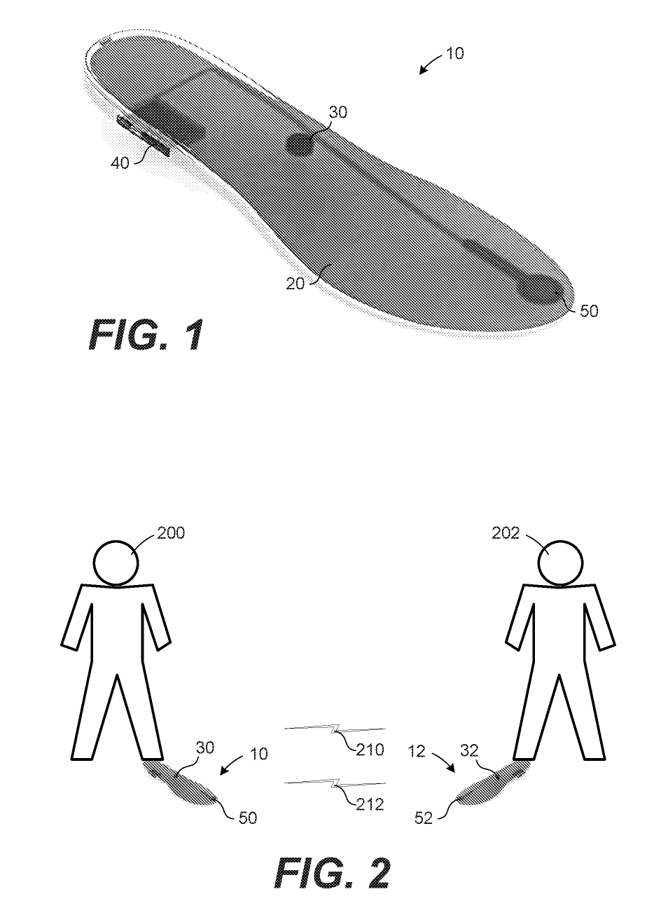

Turning to the drawings, FIG. 1 illustrates an example article 10 for communications according to various embodiments described herein. The article 10 includes an insole 20 of a shoe, a haptic feedback mechanism 30, a communications module 40, and a flexible pressure sensor 50. Before describing the components of the article 10 in greater detail, it is noted that the embodiment illustrated in FIG. 1 is provided by way of example only. Although the haptic feedback mechanism 30, communications module 40, and flexible pressure sensor 50 are shown in the insole 20, they can be integrated or incorporated into other articles of clothing and/or accessories. Further, although the haptic feedback mechanism 30, communications module 40, and flexible pressure sensor 50 are shown at certain positions within the insole 20, they can be integrated or incorporated at other locations within the insole 20. For example, in the embodiment shown in FIG. 1, the flexible pressure sensor 50 is located at a position for proximity to an individual's large toe, but it could be located at other positions where the individual can apply controlled pressure. Similarly, the haptic feedback mechanism 30 can be placed at other locations within the insole 20 where the individual can easily sense the vibration, including within the communications module 40.

The haptic feedback mechanism 30 can be embodied as any suitable mechanism that generates forces, vibrations, or motions that can be detected through touch. In that context, the haptic feedback mechanism 30 can be embodied as a motor that vibrates based on a control signal from the communications module 40. In other embodiments, the haptic feedback mechanism 30 can be embodied as tactile feedback device, such as a device that changes size, form, or stiffness based on a control signal from the communications module 40. Other types of mechanisms that generate sensory feedback that can be detected through touch can also be relied upon.

The communications module 40 can be embodied as one or more discrete and/or integrated circuits, processors, system-on-chip, communications interface, and other devices. In one embodiment, the communications module 40 includes a set of integrated circuit chips mounted together on one or more printed circuit boards. The printed circuit boards can be flexible or rigid. Each of the integrated circuit chips are designed to perform one or more particular functions, such as wired communications, wireless communications, battery charging, and/or logic processing and control.

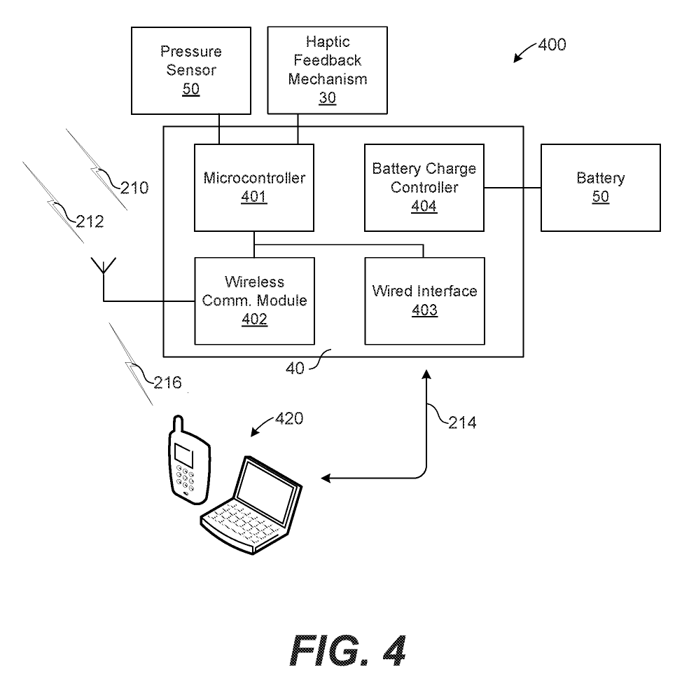

In one embodiment, the communications module 40 includes a microcontroller configured to transmit a signal using a wireless communications module based on the actuation of the flexible pressure sensor 50. In other words, when an individual presses down on the flexible pressure sensor 50 for a period of time, the microcontroller is configured to transmit a signal including a coded signal representative of the period of time. That signal can be received and decoded by another article that includes a communications module. Based on the decoded signal, the press can be presented as haptic feedback, for example, to another individual. In that way, signals transmitted from the article 10 can convey short and long presses of the flexible pressure sensor 50 as a type of encoded message using Morse code, for example, or another encoding technique that might also include the time interval between presses as part of the encoding and decoding scheme. Further, the communications module 40 is configured to receive a signal transmitted from another article and, in response to the signal, direct the haptic feedback mechanism 30 to vibrate for a period of time. In that way, seamless and covert communications can be achieved between individuals. The structure and function of the communications module 40 is described in greater detail below with reference to FIG. 4.

The flexible pressure sensor 50 can be embodied as a flexible switch, such as a flexible push-button or pressure-sensitive switch, for example. The flexible pressure sensor 50 can be sensitive to pressure and provide a closed circuit based on the application of pressure, for example, or a similar force. Similarly, the flexible pressure sensor 50 can provide an open circuit when no pressure or force is applied.

As shown in FIG. 1, the haptic feedback mechanism 30, communications module 40, and flexible pressure sensor 50 are incorporated or integrated within the insole 20. Because the insole 20 can be inserted into a shoe, the entire assembly can be hidden from view. Additionally, since the assembly is hidden, the flexible pressure sensor 50 can be pressed using an individual's toe without that movement being seen or detected by others. Thus, the embodiments described herein can be used for seamless, covert communications. At the same time, it should be appreciated that the haptic feedback mechanism 30, communications module 40, and flexible pressure sensor 50 can be incorporated in other articles of clothing or accessories.

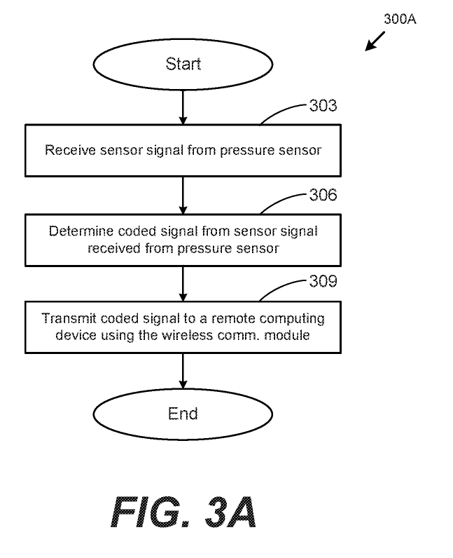

FIG. 2 illustrates an example of communications using the article 10 shown in FIG. 1 and a second article 12 according to various embodiments described herein. As shown in FIG. 2, the article 10 is placed in a shoe of an individual 200, and the second article 12, which is similar to the article 10, is placed in a shoe of another individual 202.

To communicate with each other, the individual 200 can apply pressure to the flexible pressure sensor 50 in the article 10 for periods of time and in a specific sequence using his large toe, for example. The pressure can be applied for either a longer or shorter period of time, for example, to express one of two states of an encoded message. Also, a combination of long and short presses can be applied to convey more complex messages. In turn, the microcontroller in the article 10 is configured to transmit a coded signal 210 representative of the sequence of long and short presses on the flexible pressure sensor 50. In that context, the coded signal 210 can be modulated to include one or more data bits or symbols representative of the sequence of presses applied to the flexible pressure sensor 50. These bits or symbols in the coded signal 210 can be received and decoded by the article 12 to reproduce haptic feedback using the haptic feedback mechanism 32 of the article 12 based on the period of time. That is, the coded signal 210 can be received and decoded by the article 12 and presented as haptic feedback information to the individual 202. The information can include vibrations generated by the haptic feedback mechanism 32, and the vibrations can have different periods and sequences to convey information. In that way, the coded signal 210 transmitted from the article 10 can convey the combination of short and long presses on the flexible pressure sensor 50 as an encoded message from the individual 200.

Similarly, the individual 202 can apply pressure to the flexible pressure sensor 52 in the article 12 for periods of time and in a specific sequence using his large toe, for example. In turn, the microcontroller in the article 12 is configured to transmit a coded signal 212 representative of the sequence of long and short presses applied to the flexible pressure sensor 52. The article 10 is configured to receive the coded signal 212 from the article 12 and, in response to the coded signal 212, decode the signal and direct the haptic feedback mechanism 30 to vibrate for a period of time. This vibration can be detected as information by the individual 200. Thus, two way communications between the individuals 200 and 202 can be achieved. Moreover, because the toes of the individuals 200 and 202 are not visible inside their shoes, the individuals 200 and 202 can communicate with each other covertly.

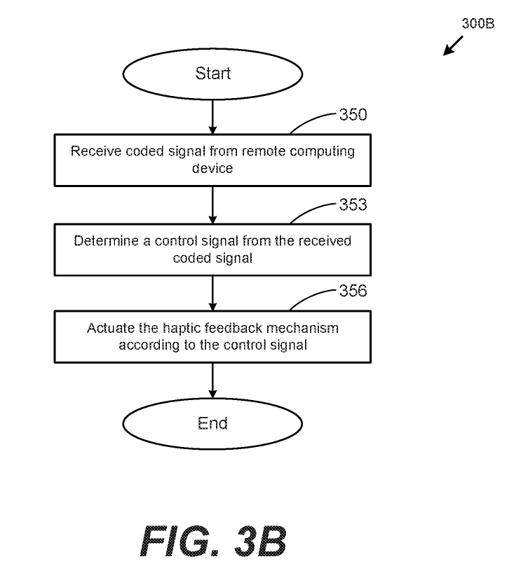

FIGS. 3A and B are flow charts illustrating example processes 300A and 300B for communicating between a first article of apparel and a second article of apparel according to one embodiment described herein. At the outset, it should be appreciated that processes 300A and 300B can be performed or executed by any suitable computing device(s), such as those described below with reference to FIG. 4, or others known in the field. Thus, while the processes 300A and 300B are described below as being performed by a computing device such as a microcontroller, the processes 300A and 300B are not limited to be performed by any particular device(s). In addition, it is understood that the flowcharts of FIGS. 3A and 3B provide merely examples of the many different types of functional arrangements that may be employed to implement the operation of the processes 300A and 300B as described herein.

With reference to FIG. 3A, shown is a flow chart illustrating the example process 300A for transmitting a coded signal of a pressure sensor from the first article of apparel 10 to the second article of apparel 12. Beginning with box 303, the microcontroller, or any other suitable computing device, receives a sensor signal from the flexible pressure sensor 50. The received signal may be received as, for example, an analog signal or a digital signal.

After the sensor signal is received, the microcontroller determines a coded signal from the sensor signal, as indicated in box 306. In some embodiments, generating the coded signal can involve determining from the sensor signal a duration of individual signal presses in a sequence. The duration of the individual signal presses can be interpreted according a messaging scheme. For example, the messaging scheme may be arranged such that a signal press of two seconds or more represents a long press and a signal press of less than two seconds represents a short press. The combination of long presses and short presses can be used to communicate a message (e.g. Morse code). One skilled in the art can use other suitable message schemes for encoding sensor signals received from the flexible pressure sensor 50.

Next, in box 309, the wireless communication module is used to transmit the coded signal to a remote computing device incorporated in the second article of apparel 12. In other embodiments, the remote computing device can be a laptop, desktop, mobile device, or any other suitable computing device. Further, in some embodiments, prior to sending wireless communication data between the first article 10 and the second article 12, or any other remote computing device, the first article 10 and the second article 12 can establish a wireless communication channel. Establishing a wireless communication channel can involve an initiation process, such as a Bluetooth pairing process, a proprietary initiation process, and other suitable wireless initiation protocols. In other embodiments, the microcontroller can facilitate transmitting the coded signal to the remote computing device using a wired interface.

With reference to FIG. 3B, shown is a flow chart illustrating an example process 300B for the first article 10 receiving a coded signal from the second article 12 and actuating the haptic feedback mechanism 30 according to the coded signal. Beginning with box 350, the microcontroller, or any other suitable computing device, receives the coded signal from a remote computing device using the communication module 40. In some embodiments, the remoting computing device can be incorporated in the second article 12.

Next, in box 353, the microcontroller can decode the coded signal and determine a control signal for the haptic feedback mechanism 30. In other words, the coded signal is converted into a control signal for the haptic feedback mechanism 30. In box 356, the microcontroller facilitates providing the control signal to the haptic feedback mechanism 30, which actuates according to the control signal. In other words, the haptic feedback mechanism 30 can provide a form of motion feedback to an individual wearing the second article 12. For example, the haptic feedback mechanism 30 can provide feedback in a form of a vibration sequence or other suitable forms of motion notification. In this scenario, the user of the second article 12 can understand the message being communicated according to the vibration sequence.

FIG. 4 illustrates an example block diagram of a communications system 400 that can be incorporated with the article 10 shown in FIG. 1 according to various embodiments described herein. The communications system 300 includes the haptic feedback mechanism 30, the communications module 40, and the flexible pressure sensor 50, each of which is described above with reference to FIG. 1. The communications system 300 further includes the battery 50, which can be embodied as any suitable type of battery in any suitable form and size, including alkaline, lithium, nickel-cadmium, nickel metal hydride, lithium-ion, or other types of batteries. The battery 50 provides power to run the haptic feedback mechanism 30, communications module 40, flexible pressure sensor 50, etc.

Among other subsystems, the communications module 40 includes a microcontroller 401, a wireless communications module 402, a wired interface 403, and a battery charge controller 404. Among various embodiments, the microcontroller 401 can be embodied as any control logic circuit or circuitry, such as a state machine, programmable logic device (PLD), field programmable gate array (FPGA), or microcontroller, among other circuitry. In one embodiment, the microcontroller 401 can be embodied as the ATmega328P picoPower 8-bit AVR RISC-based microcontroller manufactured by Atmel® of San Jose, Calif., for example, among others. The microcontroller 401 includes a number of input/output (I/O) pins for electrical interconnection with other subsystems in the communications module 40, including the wireless communications module 402, the wired interface 403, and the pressure sensor 50.

The microcontroller 401 can be configured through circuit design, the execution of computer-readable instructions stored on an integrated memory, or both, to make certain decisions and/or perform certain functions as described herein. In an embodiment where the microcontroller 401 executes computer-readable instructions, the instructions can be uploaded to the microcontroller 401 from another computing device, such as a personal computer, for example, and stored within the microcontroller 401 for execution.

In operation, the microcontroller 310 is configured to monitor a sequence of long and/or short presses on the pressure sensor 50 and direct the operation of the wireless communications module 402 based on the presses. For example, the microcontroller 310 can capture long and/or short presses on the pressure sensor 50 and direct the wireless communications module 402 to transmit a coded signal 210 including one or more symbols representative of the sequence of long and/or short presses. In other words, in response to the actuation (e.g., press using toe, etc.) of the flexible pressure sensor 50 for a period of time, the microcontroller 401 is configured to direct the wireless communications module 402 to transmit the coded signal 210 including a carrier wave having at least one coded symbol modulated thereon. The coded symbol can be based on and representative of the period of time. Further, as discussed above with reference to FIG. 2, the wireless communications module 401 is configured to receive the coded signal 212 from a second communications module (e.g., in the second article 12 shown in FIG. 2). Once received, the microcontroller 401 can decode at least one coded symbol within the coded signal 212 and direct the haptic feedback mechanism 30 to generate haptic feedback based on the coded symbol. The microcontroller 401 can direct the haptic feedback mechanism 30 to generate vibrations, for example, that last for a longer or shorter period of time based on the information decoded from the coded symbol in the coded signal 212, to convey information.

In one embodiment, the wireless communications module 402 can be embodied as any suitable duplex wireless communications module, such as a standard Bluetooth transceiver, for example, among others. Based on control instructions from the microcontroller 401, the wireless communications module 402 can modulate and demodulate data upon carrier waves, transmit the coded signal 210, and receive the coded signal 212.

The wired interface 403 can be embodied as any suitable interface between the microcontroller 401 and another computing device, such as a personal computer. In one embodiment, the wired interface 403 can be embodied as a standard universal serial bus (USB) to serial universal asynchronous receiver/transmitter (UART). The wired interface 403 can be relied upon as an interface between the microcontroller 401 and another computing device, such as a personal computer or other device for programming the microcontroller 401.

The battery charge controller 404 can be embodied as any suitable battery charger circuitry that monitors and controls the charge and discharge of the battery 50. In one embodiment, the battery charge controller 404 can be embodied as the MCP73831/2 charge management controller manufactured by Microchip® of Chandler, Ariz., for example, among others. The battery charge controller 404 can be relied upon to monitor and control the charge and discharge of the battery 50. In certain embodiments, such as where the battery 50 is a non-rechargeable alkaline or lithium battery, for example, the battery charge controller 404 can be omitted.

The subsystems of the communications module 40, including the microcontroller 401, the wireless communications module 402, the wired interface 403, and the battery charge controller 404, can be electrically interconnected together using any type of electrical circuit interconnection(s), such as a printed circuit board (PCB), for example, or other suitable structures.

As described above, instructions executed by the microcontroller 401 can be uploaded to the microcontroller 401 from an external computing device 420 and stored within the microcontroller 401 for execution. These instructions can be uploaded from the external computing device 420, which can be a smart phone, computer, or any other suitable device, to the microcontroller 401 via a wired communication link 214 through the wired interface 403 or via the wireless communication link 216 through the wireless communication module 402. Based on the instructions, the microcontroller 401 can control and direct the functions, operating parameters, and operating characteristics of the communications system 300. For example, the instructions can define what type of coded symbol is transmitted on the coded signal 210 based on the length and sequence of the presses on the pressure sensor 50.

In one example, for each individual press on the pressure sensor 50, the microcontroller 401 is configured to transmit a first coded symbol for a press on the pressure sensor 50 of about 0.3 seconds or less, and transmit a second coded symbol for a press on the pressure sensor 50 of about 1 second or longer. Similarly, the microcontroller 401 is configured to control how long the haptic feedback mechanism 30 will vibrate based on which coded symbol is received through the coded signal 212. In one embodiment, the microcontroller 401 is configured to vibrate the haptic feedback mechanism 30 for a first period of time of about 0.5 seconds when a first coded symbol is received, and vibrate the haptic feedback mechanism 30 for a second period of time of about 1 second when a second coded symbol is received. It should be appreciated, however, that the timings described above are only examples, and the communications system 300 can operate using other lengths of long and short presses and vibrations. Additionally, in other examples, one coded symbol can be representative of a length and/or sequence of presses on the pressure sensor 50.

The microcontroller 401 can also be configured with a device identifier to create a private network. For example, pre-defined device identifiers can be programmed into one or more communications systems similar to the communications system 300. In that case, any two or more of the communications systems that share a common device identifier are capable of communications. In that way, private, seamless communications can be achieved between two or more individual systems.

In summary, the communications systems described herein can be integrated into a shoe insole or other article of clothing and use a haptic feedback mechanism and flexible pressure sensor for seamless, covert communications. The communications modules described herein include a wireless communications module for wireless communications, a wired interface for wired communications, a microcontroller, and a battery charge controller. The flexible pressure sensor can be actuated by an individual's toe, for example, and communication between two communications nodes can be coded by using a combination of long and short presses on the pressure sensor.

Although embodiments have been described herein in detail, the descriptions are by way of example. The features of the embodiments described herein are representative and, in alternative embodiments, certain features and elements may be added or omitted. Additionally, modifications to aspects of the embodiments described herein may be made by those skilled in the art without departing from the spirit and scope of the present invention defined in the following claims, the scope of which are to be accorded the broadest interpretation so as to encompass modifications and equivalent structures

At least the following is claimed:

1. A communications article, comprising:
an article of apparel;
a haptic feedback mechanism incorporated with the article of apparel;
a communications module incorporated with the article of apparel; and
a flexible pressure sensor incorporated in the article of apparel to capture information for wireless communications via the communications module to a second article of apparel.

2. The communications article according to claim 1, wherein the communications module comprises:
a wireless communications module for wireless communications;
a wired interface for wired communications;
a microcontroller coupled to the flexible pressure sensor, the haptic feedback mechanism, the wireless communications module, and the wired interface; and
a battery charge controller.

3. The communications article according to claim 2, wherein, in response to a sequence of long and short actuations of the flexible pressure sensor, the microcontroller is configured to direct the wireless communications module to transmit a signal representative of the actuations.

4. The communications article according to claim 2, wherein, in response to actuation of the flexible pressure sensor for a period of time, the microcontroller is configured to direct the wireless communications module to transmit a signal based on the period of time.

5. The communications article according to claim 2, wherein:
the wireless communications module is configured to receive a signal from a second communications module incorporated with the second article of apparel; and
in response to the signal from the second communications module, the microcontroller is configured to direct the haptic feedback mechanism to vibrate for a period of time.

6. The communications article according to claim 2, wherein:
the wireless communications module is configured to receive a signal from a second communications module incorporated with the second article of apparel; and
the microcontroller is configured to decode the signal to identify information in the signal and direct the haptic feedback mechanism to vibrate for a period of time based on the information.

7. The communications article according to claim 1, wherein the article of apparel is a shoe, and at least one of the haptic feedback mechanism, the communications module, and the flexible pressure sensor are incorporated within an insole of the shoe,

8. A communications article, comprising:
a feedback mechanism incorporated with an article of apparel;
a communications module incorporated with the article of apparel; and
a sensor incorporated in the article of apparel to capture information for wireless communications via the communications module.

9. The communications article according to claim 8, wherein the communications article comprises:
a wireless communications module; and
a microcontroller coupled to the sensor, the feedback mechanism, and the wireless communications module.

10. The communications article according to claim 9, wherein, in response to a sequence of long and short actuations of the sensor for a period of time, the microcontroller is configured to direct the wireless communications module to transmit a signal representative of the actuations.

11. The communications article according to claim 9, wherein:
the feedback mechanism comprises a haptic feedback mechanism;
the wireless communications module is configured to receive a signal from a second communications module incorporated with a second article of apparel; and
in response to the signal from the second communications module, the microcontroller is configured to direct the feedback mechanism to vibrate for a period of time.

12. The communications article according to claim 8, wherein the article of apparel is a shoe, and at least one of the feedback mechanism, the communications module, and the sensor are incorporated with an insole of the shoe.

13. A method, comprising:
receiving, via at least one computing device, a sensor signal from a flexible pressure sensor incorporated in an article of apparel;
determining, via the at least one computing device, a coded signal from the sensor signal according to a messaging scheme; and
initiating, via the at one computing device, a communication module to transmit the coded signal to a remote computing device.

14. The method of claim 13, wherein the article of apparel comprises a first article of apparel, and wherein the remote computing device is incorporated in a second article of apparel.

15. The method of claim 14, wherein the first article of apparel is a shoe, and wherein the flexible pressure sensor, the at least one computing device, and the communication module are incorporated within an insole of the shoe.

16. The method of claim 13, wherein determining the coded signal from the sensor signal according to the messaging scheme further comprises determining, via the at one computing device, a sequence of a plurality of short presses and a plurality of long presses from the sensor signal.

17. The method of claim 16, wherein the plurality of short presses can represent a first subset of a plurality of sensor signal presses for less than a time period threshold and the plurality of long presses can represent a second subset of the plurality of sensor signal presses that meet or exceed the time period threshold.

18. The method of claim 13, wherein the article of apparel comprises a haptic feedback mechanism.

19. The method of claim 18, wherein the coded signal comprises a first coded signal, and further comprising:
receiving, via the at least one computing device, a second coded signal from the remote computing device, the coded signal being received by the communication module;
determining, via the at least one computing device, a control signal from the second coded signal; and
actuating, via the at least one computing device, the haptic feedback mechanism according to the control signal.

20. The method of claim 19, wherein actuating the haptic feedback mechanism comprises initiating a vibration sequence according to the control signal.
